(19) United States
(12) Patent Application Publication
(10) Pub. No.: US 2018/0170290 A1
(43) Pub. Date: Jun. 21, 2018

(54) A METHOD AND A SYSTEM FOR PROVIDING AN AUXILIARY UNIT CONTROL PROFILE FOR CONTROLLING AN AUXILIARY UNIT IN A MOTOR VEHICLE

(71) Applicant: Scania CV AB, Södertälje (SE)

(72) Inventors: Henrik FLEMMER, Hägersten (SE); Anders LARSSON, Tullinge (SE); Björn JOHANSSON, Älvsjö (SE); Fredrik STRÅÅT, Stockholm (SE); Tommy NILSSON, Södertälje (SE); Sebastian ZAMANI, Stockholm (SE)

(21) Appl. No.: 15/735,258

(22) PCT Filed: Apr. 12, 2016
(86) PCT No.: PCT/SE2016/050315

§ 371 Date: Dec. 11, 2017

(30) Foreign Application Priority Data
Jun. 17, 2015 (SE) 1550836-9

(51) Int. Cl. B60R 16/023; B60H 1/00

(52) U.S. Cl. CPC B60R 16/0236; B60Y 2300/52; B60Y 2300/51; B60H 1/00771

(57) ABSTRACT

A method and a system (200) for providing an auxiliary unit control profile for controlling an auxiliary unit (201) in a motor vehicle (202) including receiving travelling route data relating to a travelling route of the motor vehicle and based thereon, identifying an expected future travelling route. Based on the expected future travelling route and on auxiliary unit operation data, an auxiliary unit control profile for controlling the auxiliary unit during travel along the expected future travelling route is determined in a processing unit (204). The auxiliary unit control profile is outputted to a control unit (206) configured to execute the auxiliary unit control profile and control the auxiliary unit based on the auxiliary unit control profile.

### CROSS-REFERENCE TO RELATED APPLICATIONS

The present application is a 35 U.S.C. §§ 371 national phase conversion of PCT/SE2016/050315, filed Apr. 12, 2016, which claims priority of Swedish Patent Application No. 1550836-9, filed Jun. 17, 2015, the contents of which are incorporated by reference herein. The PCT International Application was published in the English language.

### TECHNICAL FIELD OF THE INVENTION

The invention relates to a method and a system for providing an auxiliary unit control profile for controlling an auxiliary unit in a motor vehicle during operation of the motor vehicle. The invention also relates to a computer program and to a computer program product.

An auxiliary unit of a motor vehicle may be for example an air conditioning system, a heating system, a cooling system, a generator, a compressor, a pump, or any other auxiliary system not directly needed for producing torque.

### BACKGROUND AND PRIOR ART

A motor vehicle normally comprises several auxiliary units contributing to the total fuel consumption of the motor vehicle. The powering of the auxiliary units is normally based on need, either automatically or on command of a driver of the motor vehicle. Since there is an ongoing struggle to reduce fuel consumption and emissions in the form of carbon dioxide (CO₂), nitrogen oxide (NOx) and particulate matter emissions from motor vehicles, it is desirable to provide means of powering auxiliary units not only based on need, but also with the total fuel consumption of the motor vehicle in mind.

EP2036777 discloses a method and a system for providing driving data of a motor vehicle to its driver, in which present driving data are compared to reference data and an evaluation value is presented to the driver. This enables the driver to evaluate his driving with the purpose of reducing the fuel consumption of the motor vehicle. According to the disclosed method, driving data associated with auxiliary units in the motor vehicle may be obtained so that their contribution to the fuel consumption of the motor vehicle may be presented to the driver. The driver can, based on the presented driving data, switch off auxiliary systems having a large contribution to the fuel consumption of the motor vehicle, thus reducing overall carbon dioxide (CO₂) emissions.

However, a problem with the method disclosed in EP2036777 is that it relies on the driver to manually adjust the powering of the auxiliary units in the motor vehicle based on the present fuel consumption. This is inconvenient for the driver, in particular if several auxiliary units are operated simultaneously and if the travelling route of the vehicle entails varying driving conditions, for example in a varying topography.

### SUMMARY OF THE INVENTION

It is an object of the present invention to solve the above identified problem and thus provide a solution by means of which the auxiliary units' contribution to the total fuel consumption of the motor vehicle, and thereby also to the total emissions of CO₂, nitrogen oxides (NOx) and particulate matter, may be controlled in a more efficient and convenient manner.

According to a first aspect of the present invention, this object is achieved by means of the method initially defined, comprising:
in a route identification unit, receiving travelling route data relating to a travelling route of the motor vehicle,
based on said travelling route data, identifying an expected future travelling route of the motor vehicle and outputting said expected future travelling route to a processing unit,
in the processing unit, receiving auxiliary unit operation data relating to a desired operation of said auxiliary unit,
in the processing unit, based on said expected future travelling route of the motor vehicle and on said auxiliary unit operation data, determining an auxiliary unit control profile for controlling said auxiliary unit during travel along the expected future travelling route,
outputting said auxiliary unit control profile to a control unit located in the motor vehicle, wherein said control unit is configured to execute the auxiliary unit control profile and control the auxiliary unit based on said auxiliary unit control profile.

The method according to invention thus takes the expected future travelling route of the motor vehicle into account and determines an auxiliary unit control profile which can be used for controlling the powering of one or more auxiliary units in the motor vehicle. The auxiliary unit control profile may preferably be optimized for low fuel consumption. Upon execution of the auxiliary unit control profile in the control unit, the auxiliary unit is thus automatically operated in a fuel efficient manner, without the need for the driver to manually check the fuel consumption associated with each auxiliary unit and switch it off if judged necessary.

According to an embodiment of this aspect of the invention, the method further comprises the step of identifying a geographic location and a direction of travel of the motor vehicle. In this step, a geographical locator device in the form of e.g. a GPS (global positioning system) device or a device using e.g. triangulation or other methods for determining a geographic location can be used. In this way, a very accurate determination of the location of the motor vehicle may be obtained and thereby also of the expected future travelling route and of the topography, traffic conditions, etc. along the expected future travelling route.

According to a further embodiment of this aspect of the invention, the identified geographic location and direction of travel are used in the step of identifying an expected future travelling route of the motor vehicle. The identification can be based on stored information about previously traveled routes of the motor vehicle, or on input from the driver as to a planned travelling route.

According to a further embodiment of this aspect of the invention, the auxiliary unit control profile is determined based on at least one of:
geographic information data designating the expected future travelling route,
topographic data reflecting the topography along the expected future travelling route,
traffic data reflecting the traffic situation along the expected future travelling route,
weather data relating to weather conditions along the expected future travelling route.

By taking such information into account when determining the auxiliary unit control profile, powering of the auxiliary unit can be optimized to decrease the fuel consumption of the motor vehicle. Using e.g. topographic data is particularly useful for creating an auxiliary unit control profile for a travelling route which is not previously traveled by the motor vehicle, in which case there is no stored driving data reflecting driving conditions along the expected future travelling route.

According to another embodiment of this aspect of the invention, the travelling route data comprises driving data of the motor vehicle describing at least one aspect of how the motor vehicle has been operated during a well-defined time period. The driving data can be used e.g. to identify a location of the motor vehicle and an expected future travelling route, since driving data are often intimately connected to the travelling route of the vehicle.

According to a further embodiment of this aspect of the invention, said driving data comprises data relating to at least one of speed, acceleration, steering angle, engine speed, engine torque, engine load, gear ratio, fuel consumption, and current road inclination. These parameters may be used on their own or in combination to identify a travelling route of the motor vehicle.

According to another embodiment of this aspect of the invention, the step of identifying an expected future travelling route of the motor vehicle comprises comparing a set of driving data associated with a present travelling route of the motor vehicle to at least one stored set of driving data associated with a previously traveled route of the motor vehicle, and based on said comparison identifying the expected future travelling route. In this case, the travelling route data are collected using e.g. various sensors located in the vehicle. This is an accurate way of determining an expected future travelling route of the vehicle, and can be used on its own or in combination with data from a geographic locator device.

According to another embodiment of this aspect of the invention, the auxiliary unit control profile is determined based on at least one driving data profile associated with the expected future travelling route, wherein the at least one driving data profile is chosen from an engine load profile, an engine torque profile, a gear shifting profile, a fuel consumption profile, an engine rotation speed profile, and an engine temperature profile. Given that the motor vehicle has previously traveled the expected future travelling route and that a driving data profile associated with this travelling route has been stored in a database, this is an efficient way of obtaining an optimized auxiliary unit control profile. The auxiliary unit control profile may be recalculated taking e.g. traffic conditions, weather conditions, or vehicle data into account, but it is also possible to provide a previously created auxiliary control profile.

According to yet another embodiment of this aspect of the invention, the step of determining the auxiliary unit control profile is carried out in a central service node located at a distance from the motor vehicle. In this way, the motor vehicle itself does not need to include the processing unit needed to determine the auxiliary unit control profile, which allows saving weight in the vehicle. Moreover, it is easier to update the algorithms used to determine the auxiliary control profile in a central service node, ensuring that the algorithms used are up to date. Finally, a central service node has much more computational power compared to an on-board embedded system.

According to another embodiment of this aspect of the invention, the step of identifying the expected future travelling route of the motor vehicle is carried out in said central service node. Any driving data associated with previously traveled routes may thus be stored in the central service node and there is no need to keep large databases in the motor vehicle.

According to a further embodiment of this aspect of the invention the step of receiving travelling route data and auxiliary unit operation data is carried out by receiving a first data message comprising said travelling route data and said auxiliary unit operation data from a data communication unit in the motor vehicle in the central service node over at least one network and a wireless interface, and the step of outputting said auxiliary unit control profile is carried out by sending a second data message comprising said auxiliary unit control profile from the central service node to the data communication unit in the motor vehicle over said at least one network and said wireless interface. This is an efficient way of transferring data when the vehicle comprises a data communication unit configured to receive data over a wireless interface. The data communication unit may preferably be included in the control unit of the vehicle.

According to a further embodiment of this aspect of the invention, the first data message comprises motor vehicle data relating to at least one of motor vehicle weight, tire pressure, fuel quality, and state of on-board energy storages, such as batteries, pressure tanks, and coolant fluids.

According to a further embodiment of this aspect of the invention, said motor vehicle data are used in the step of determining the auxiliary unit control profile. This enables adaptation of the auxiliary unit control profile to the present motor vehicle conditions.

According to a second aspect of the present invention, the above mentioned object is achieved by means of the system initially defined, characterized in that the system comprises:
a route identification unit, and
a processing unit,
   wherein the route identification unit is configured to receive travelling route data relating to a present travelling route of the motor vehicle, and based on said travelling route data identify an expected future travelling route of the motor vehicle and output data describing said expected future travelling route to the processing unit, and
wherein the processing unit is configured to receive on one hand data describing the expected future travelling route from the route identification unit, and on the other hand auxiliary unit operation data relating to a desired operation of said auxiliary unit, and based on said data to determine an auxiliary unit control profile for controlling said auxiliary unit during travel along the expected future travelling route when executed in a control unit located in the motor vehicle, and to output said auxiliary unit control profile to said control unit.

The system according to the invention may be located either on or off the motor vehicle. The advantages of such a system as well as preferred embodiments thereof are apparent from the above discussion relating to the proposed method.

According to one embodiment of the second aspect of the invention, the system comprises:
a central service node comprising said route identification unit and said processing unit,
a primary interface towards at least one network, said network having a secondary interface configured to communicate wirelessly with a data communication unit located in the motor vehicle, wherein the central service node is configured to:
receive a first data message from the motor vehicle comprising said travelling route data and said auxiliary unit operation data,
in response to said first data message, identify said future travelling route and determine said auxiliary unit control profile, and
send a second data message comprising said auxiliary unit control profile from the central service node to the data communication unit in the motor vehicle over said at least one network.

The data communication unit is preferably comprised in the control unit in the motor vehicle.

According to a further aspect of the invention the object is achieved by a computer program comprising computer program code for causing a computer to implement the proposed method when the computer program is executed in the computer.

According to a further aspect of the invention the object is achieved by a computer program product comprising a non-transitory data storage medium which can be read by a computer and on which the program code of the proposed computer program is stored.

Further advantages as well as advantageous features of the present invention will appear from the following detailed description.

### BRIEF DESCRIPTION OF THE DRAWINGS

Embodiments of the invention will in the following be described with reference to the appended drawings, in which:

FIG. 1 schematically shows a system according to an embodiment of the invention,

FIG. 2 schematically shows a system according to another embodiment of the invention,

FIG. 3 is a flow chart illustrating a method according to an embodiment of the invention,

FIG. 4 is a flow chart illustrating a method according to another embodiment of the invention.

### DETAILED DESCRIPTION OF EMBODIMENTS OF THE INVENTION

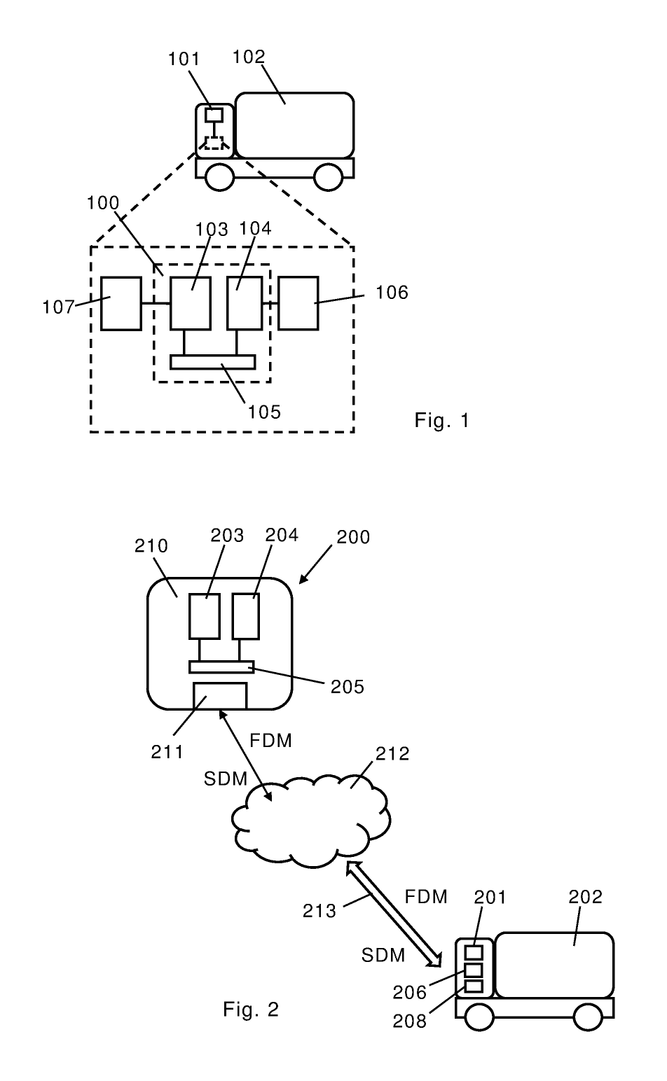

FIG. 1 shows a system 100 for providing an auxiliary unit control profile for controlling an auxiliary unit 101 in a motor vehicle 102 according to a first embodiment of the invention. The system 100 according to this embodiment is located on-board the motor vehicle 102 and comprises a route identification unit 103 and a processing unit 104 communicating via a databus 105. The route identification unit 103 is configured to receive travelling route data relating to a travelling route of the motor vehicle 102 from a geographical locator device 107, also located in the motor vehicle 102. The route identification unit 103 may instead be configured to receive travelling route data in the form of driving data of the motor vehicle 102, and/or to receive input from the driver of the motor vehicle 102 regarding a planned travelling route. Based on the received travelling route data, the route identification unit 103 is configured to identify an expected future travelling route of the motor vehicle 102. The route identification unit 103 is further configured to output data describing the identified expected future travelling route to the processing unit 104.

The processing unit 104 is configured to receive these data describing the identified expected future travelling route from the route identification unit 103, and also to receive auxiliary unit operation data relating to a desired operation of said auxiliary unit 101. These auxiliary unit operation data can be input data from a driver of the motor vehicle 102, but also data which are set by some other system in the motor vehicle 102. Based on said expected future travelling route and said auxiliary unit operation data, the processing unit 104 is configured to determine an auxiliary unit control profile for controlling said auxiliary unit 101 during travel along the expected future travelling route when executed in a control unit 106 located in the motor vehicle 102. It is further configured to output the auxiliary unit control profile to the control unit 106.

FIG. 2 shows a system 200 for providing an auxiliary unit control profile for controlling an auxiliary unit 201 in a motor vehicle 202 according to a second embodiment of the invention. The system 200 according to this embodiment is located at a distance from the motor vehicle 202 and comprises a central service node 210. The central service node 210 comprises a route identification unit 203 and a processing unit 204 communicating via a databus 205. The system further comprises a primary interface 211 towards at least one network 212. The network has a secondary interface 213 configured to communicate wirelessly with a data communication unit 208 located in the motor vehicle 202.

The central service node 210 is configured to receive a first data message FDM from the motor vehicle 202 comprising on one hand travelling route data relating to a travelling route of the motor vehicle 202, and on the other hand auxiliary unit operation data relating to a desired operation of the auxiliary unit 201. In response to said first data message FDM, the route identification unit 203 is configured to identify an expected future travelling route of the motor vehicle 202 based on said travelling route data, and to output data describing said expected future travelling route to the processing unit 204. The travelling route data relating to a travelling route of the motor vehicle 202 may be data from a geographical locator device located in the motor vehicle 202, driving data of the motor vehicle 202, and/or input data from the driver of the motor vehicle 202 regarding a planned travelling route.

The processing unit 204 is configured to receive on one hand data describing the expected future travelling route from the route identification unit, and on the other hand the auxiliary unit operation data. Based on said data, the processing unit 204 is configured to determine an auxiliary unit control profile for controlling the auxiliary unit 201 during travel along the expected future travelling route when executed in a control unit 206 located in the motor vehicle 202. It is further configured to output said auxiliary unit control profile to said control unit 206 by sending a second data message SDM comprising said auxiliary unit control profile from the central service node 210 to the data communication unit 208 in the motor vehicle 202 over said at least one network 212 and said interfaces 211, 213.

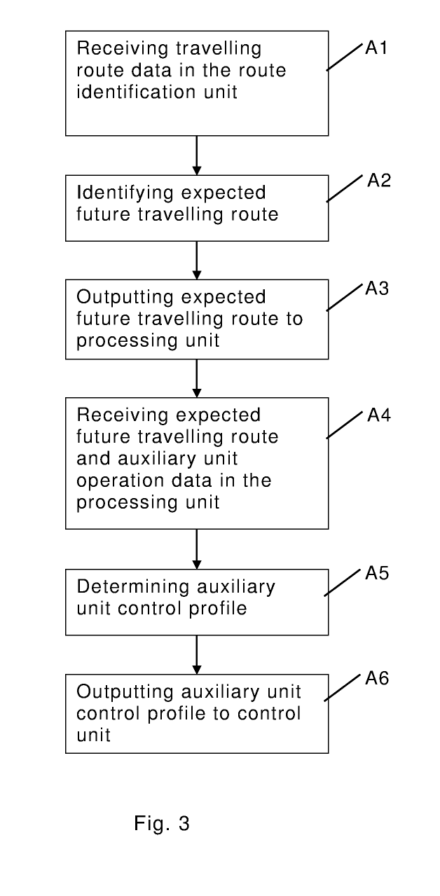

FIG. 3 schematically illustrates a method for providing an auxiliary unit control profile according to the invention, using a system as shown in FIG. 1 or in FIG. 2. In a first step A1, travelling route data relating to a travelling route of the motor vehicle 102, 202 are received in the route identification unit 103, 203. Based on said travelling route data, an expected future travelling route of the motor vehicle 102, 202 is identified in a second step A2. In a third step A3, said expected future travelling route is outputted to the processing unit 104, 204. In a fourth step A4, auxiliary unit operation data relating to a desired operation of the auxiliary unit 101, 201 and data relating to the expected future travelling route as identified in the route identification unit 103, 203 are received in the processing unit 104, 204. In a fifth step A5, an auxiliary unit control profile for controlling said auxiliary unit during travel along the expected future travelling route is determined in the processing unit 104, 204. The auxiliary unit control profile is determined based on said expected future travelling route of the motor vehicle 102, 202 and on said auxiliary unit operation data. In a sixth step A6, the auxiliary unit control profile is outputted to the control unit 106, 206 located in the motor vehicle 102, 202.

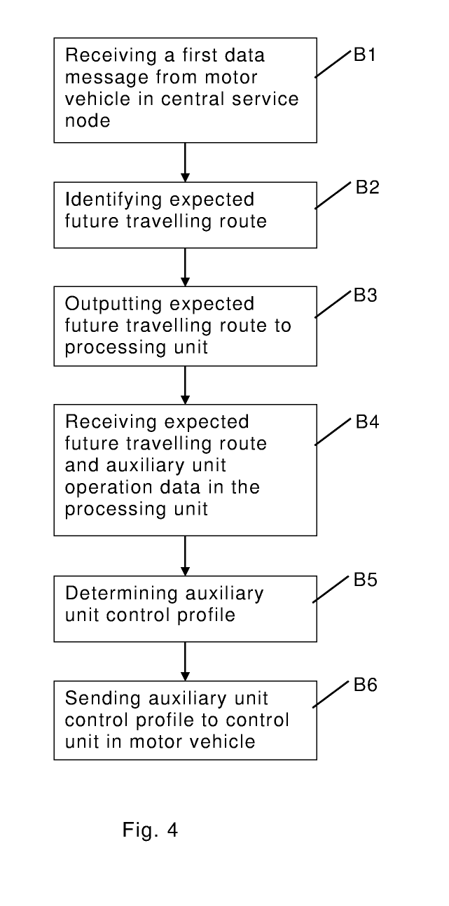

Reference is now made to FIG. 4, in which a method according to an embodiment of the invention in which the auxiliary unit control profile is determined in a central service node 210 located at a distance from the motor vehicle 202 as shown in FIG. 2 is illustrated. In a first step B1, a first data message FDM from the motor vehicle 202 is received in the central service node 210. The sending of the first data message FDM from the motor vehicle 202 may be initiated by a driver of the motor vehicle 202, or performed automatically. The first data message FDM is sent over the network 212 and the primary and secondary interfaces 211, 213 and comprises route travelling data allowing determination of the expected future travelling route, as well as auxiliary unit operation data relating to a desired operation of the auxiliary unit 201 of the motor vehicle 202. In a second step B2, an expected future travelling route is identified in the route identification unit 203. In a third step B3, said expected future travelling route is outputted to the processing unit 204. In a fourth step B4, auxiliary unit operation data relating to a desired operation of the auxiliary unit 201 and data relating to the expected future travelling route as identified in the route identification unit 203 are received in the processing unit 204. In a fifth step B5, an auxiliary unit control profile is determined in the processing unit 204. The auxiliary unit control profile is determined based on said expected future travelling route of the motor vehicle 202 and on said auxiliary unit operation data. In a sixth step B6, the auxiliary unit control profile is sent to the data communication unit 208 of the motor vehicle over the network 212 and the primary and secondary interfaces 211, 213. From the data communication unit 208, the auxiliary unit control profile is outputted to the control unit 206.

Regardless of whether the auxiliary unit control profile is determined on-board the motor vehicle 102 or in a central service node 210 located at a distance from the motor vehicle 202, the expected future travelling route can be determined in different ways.

In one embodiment, the travelling route data used to determine the expected future travelling route are driving data of the motor vehicle 102, 202 describing at least one aspect of how the motor vehicle 102, 202 has been operated during a well-defined time period. The driving data may e.g. relate to one or more of speed, acceleration, steering angle, engine speed, engine torque, engine load, gear ratio, fuel consumption, and current road inclination. The expected future travelling route of the motor vehicle 102, 202 may in this case be determined by means of comparison of a set of driving data associated with a present travelling route of the motor vehicle 102, 202 to stored sets of driving data associated with previously traveled routes of the motor vehicle 102, 202.

In another embodiment, a geographic location and a direction of travel of the motor vehicle 102, 202 are determined using e.g. a geographic locator device 107. The identified geographic location and direction of travel are used in the step of identifying an expected future travelling route of the vehicle. It is also possible to combine driving data and geographical information data for identifying the expected future travelling route, and/or to use input data from the driver relating to a planned travelling route.

Also the auxiliary unit control profile may in both above discussed cases be determined in different ways, regardless of whether this is performed on-board the motor vehicle 102 or in a central service node 210. On one hand, the auxiliary unit control profile can be determined based on at least one of geographic information data designating the expected future travelling route, topographic data reflecting the topography along the expected future travelling route, traffic data reflecting the traffic situation along the expected future travelling route, and/or weather data relating to weather conditions along the expected future travelling route. On the other hand, the auxiliary unit control profile can be determined based on at least one driving data profile associated with the expected future travelling route. The driving data profile(s) can be an engine load profile, an engine torque profile, a gear shifting profile, a fuel consumption profile, an engine rotation speed profile, and/or an engine temperature profile. Such driving data profiles for commonly traveled routes may be stored in a database located either on-board the motor vehicle 102 or in the central service node 210. A combination of at least one driving data profile and geographic information data, topographic data, traffic data, and/or weather data may also be used, depending on which data are available and on desired precision in the determination of the auxiliary unit control profile. Also motor vehicle data relating to at least one of motor vehicle weight, tire pressure, fuel quality, and state of on-board energy storages, such as batteries, pressure tanks, and coolant fluids, may be used in the step of determining the auxiliary unit control profile. Such data may be comprised in the first data message (FDM) or communicated directly to an on-board processing unit 104.

The driver of the motor vehicle 102, 202 may, before execution of the auxiliary unit control profile in the control unit 106, 206, be prompted to accept execution. The auxiliary unit control profile would in that case only be executed upon acceptance from the driver.

All of the process steps, as well as any sub-sequence of steps, described above with reference to FIGS. 3-4, may be controlled by means of a programmed computer apparatus. Moreover, although the embodiments of the invention described above with reference to the drawings comprise a computer apparatus and processes performed in a computer apparatus, the invention thus also extends to computer programs, particularly computer programs on or in a carrier, adapted for putting the invention into practice. The program may be in the form of source code, object code, a code intermediate source and object code such as in partially compiled form, or in any other form suitable for use in the implementation of the process according to the invention. The program may either be a part of an operating system, or be a separate application. The carrier may be any entity or device capable of carrying the program. For example, the carrier may comprise a storage medium, such as a Flash memory, a ROM (Read Only Memory), for example a DVD (Digital Video/Versatile Disk), a CD (Compact Disc) or a semiconductor ROM, an EPROM (Erasable Programmable Read-Only Memory), an EEPROM (Electrically Erasable Programmable Read-Only Memory), or a magnetic recording medium, for example a floppy disc or hard disc. Further, the carrier may be a transmissible carrier such as an electrical or optical signal which may be conveyed via electrical or optical cable or by radio or by other means. When the program is embodied in a signal which may be conveyed directly by a cable or other device or means, the carrier may be constituted by such cable or device or means. Alternatively, the carrier may be an integrated circuit in which the program is embedded, the integrated circuit being adapted for performing, or for use in the performance of, the relevant processes.

The invention is of course not in any way restricted to the embodiments described above. On the contrary, many possibilities to modifications thereof will be apparent to a person with ordinary skill in the art without departing from the basic idea of the invention such as defined in the appended claims.

1. A method of providing an auxiliary unit control profile for controlling an auxiliary unit in a motor vehicle, the method comprising:
receiving travelling route data relating to a travelling route of the motor vehicle in a route identification unit;
based on said travelling route data, identifying an expected future travelling route of the motor vehicle and outputting said expected future travelling route to a processing unit;
receiving auxiliary unit operation data in the processing unit relating to a desired operation of said auxiliary unit;
based on said expected future travelling route of the motor vehicle and on said auxiliary unit operation data, determining in the processing unit an auxiliary unit control profile for controlling said auxiliary unit during travel along the expected future travelling route;
outputting said auxiliary unit control profile to a control unit located in the motor vehicle, wherein said control unit is configured to execute the auxiliary unit control profile and to control said auxiliary unit based on said auxiliary unit control profile.

2. The method according to claim 1, further comprising:
identifying a traveling route of the motor vehicle by identifying a geographic location and a direction of travel of the motor vehicle.

3. The method according to claim 2, wherein the identified geographic location and direction of travel are used in the step of identifying an expected future travelling route of the motor vehicle.

4. The method according to claim 3, wherein the auxiliary unit control profile is determined based on at least one of:
geographic information data designating the expected future travelling route;
topographic data reflecting the topography along the expected future travelling route;
traffic data reflecting the traffic situation along the expected future travelling route; and
weather data relating to weather conditions along the expected future travelling route.

5. The method according to claim 3, wherein the travelling route data comprises driving data of the motor vehicle describing at least one aspect of how the motor vehicle has been operated during a well-defined time period.

6. The method according to claim 5, wherein said driving data comprises data relating to at least one of speed, acceleration, steering angle, engine speed, engine torque, engine load, gear ratio, fuel consumption, and current road inclination of said motor vehicle.

7. The method according to claim 5, wherein the step of identifying an expected future travelling route of the motor vehicle comprises comparing a set of driving data associated with a present travelling route of the motor vehicle to at least one stored set of driving data associated with a previously traveled route of the motor vehicle, and based on said comparison, identifying the expected future travelling route.

8. The method according to claim 6, wherein the auxiliary unit control profile is determined based on at least one driving data profile associated with the expected future travelling route, wherein the at least one driving data profile is chosen from an engine load profile, an engine torque profile, a gear shifting profile, a fuel consumption profile, an engine rotation speed profile, and an engine temperature profile.

9. The method according to claim 1, wherein the step of determining the auxiliary unit control profile is carried out in a central service node located at a distance from the motor vehicle.

10. The method according to claim 9, wherein the step of identifying the expected future travelling route of the motor vehicle is carried out in said central service node.

11. The method according to claim 10, wherein the step of receiving travelling route data and auxiliary unit operation data is carried out by receiving a first data message (FDM) comprising said travelling route data and said auxiliary unit operation data from a data communication unit in the motor vehicle in said central service node over at least one network and a wireless interface; and
wherein the step of outputting said auxiliary unit control profile is carried out by sending a second data message (SDM) comprising said auxiliary unit control profile from said central service node to said data communication unit in the motor vehicle over said at least one network and said wireless interface.

12. The method according to claim 11, wherein said first data message (FDM) comprises motor vehicle data relating to at least one of motor vehicle weight, tire pressure, fuel quality, and state of on-board energy storages, comprised of batteries, pressure tanks, and coolant fluids.

13. The method according to claim 12, wherein said motor vehicle data are used in the step of determining the auxiliary unit control profile.

14. A system for providing an auxiliary unit control profile for controlling an auxiliary unit in a motor vehicle;
the system comprises:
a vehicle route identification unit; and
a processing unit;
wherein the route identification unit is configured to receive travelling route data relating to a travelling route of the motor vehicle, and based on said travelling route data to identify an expected future travelling route of the motor vehicle and output data describing said expected future travelling route to the processing unit, and wherein the processing unit is configured to receive on one hand data describing the expected future travelling route from the route identification unit, and on the other hand auxiliary unit operation data relating to a desired operation of said auxiliary unit, and, based on said data, to determine an auxiliary unit control profile for controlling said auxiliary unit during travel along said expected future travelling route when executed in a control unit located in the motor vehicle, and to output said auxiliary unit control profile to said control unit.

15. The system according to claim 14, further comprising:
a central service node comprising said route identification unit and said processing unit;
a primary interface towards at least one network, said at least one network having a secondary interface configured to communicate wirelessly with a data communication unit located in the motor vehicle;
wherein said central service node is configured to:
receive a first data message (FDM) from the motor vehicle said first data message (FDM) comprising said travelling route data and said auxiliary unit operation data;
in response to said first data message (FDM), to identify said future travelling route and determine said auxiliary unit control profile, and
send a second data message (SDM) comprising said auxiliary unit control profile from said central service node to said data communication unit in the motor vehicle over said at least one network.

16. (canceled)

17. A computer program product comprising a non-transitory data storage medium which can be read by a computer program code of a computer program stored on said storage medium; and
said computer program code is configured for causing a computer to implement a method according to claim 1 when said computer program is executed in said computer.
